(19) United States
(12) Patent Application Publication
(10) Pub. No.: US 2025/0262897 A1
(43) Pub. Date: Aug. 21, 2025

(54) SYSTEM AND METHOD FOR SETTING TIRE SENSOR COMMUNICATION PROTOCOL OR IDENTIFICATION CODE

(71) Applicant: ORANGE ELECTRONIC CO., LTD, TAICHUNG CITY (TW)

(72) Inventors: JIAN-ZHI WANG, TAICHUNG CITY (TW); MING YUNG HUANG, TAICHUNG CITY (TW); CHIN YAO HSU, TAICHUNG CITY (TW)

(73) Assignee: ORANGE ELECTRONIC CO., LTD, TAICHUNG CITY (TW)

(21) Appl. No.: 18/583,545

(22) Filed: Feb. 21, 2024

(51) Int. Cl. B60C 23/04; B60C 23/20; G01M 17/02

(52) U.S. Cl. CPC B60C 23/0479; G01M 17/02; B60C 23/0488; B60C 23/20

(57) ABSTRACT

A system for setting a tire sensor communication protocol, comprising: an electronic device and a handheld mobile device. The electronic device, connected to a first database, displays a link diagram upon entering vehicle data. The handheld device, linked to a second database, retrieves a communication protocol from either the first or second database after scanning the link diagram. The communication protocol used for programming a corresponding tire sensor. This facilitates the selection of the appropriate communication protocol for different vehicle models without needing to input vehicle data on the handheld device, overcoming the challenges of small screen and input errors.

### RELATED APPLICATIONS

### Background

### Technical Field

The invention pertains to a system and procedural steps for establishing a communication protocol or an identification code for a tire sensor, utilizing a link diagram scanned via a handheld mobile device.

### Description of Related Art

Car manufacturers, before dispatching vehicles from the factory, install tire sensors. These sensors, over time, may deplete or completely exhaust their power and necessitate replacement. In the aftermarket (AM), tire pressure monitoring system (TPMS) manufacturers produce new tire sensors as substitutes. These manufacturers, informed by market research, pre-identify specific tire sensor types used by original equipment manufacturers (OEMs) and store this data, including suitable communication protocol for different vehicle models, in their databases.

However, due to the multitude of vehicle brands or car makers in the market, each brand releases different models every year. Therefore, combining maker (or brand), year, and model data (maker, model and year can abbreviate MMY) results in a vast array of vehicle data stored in databases. Each vehicle data typically corresponds to a specific communication protocol. When replacing tire sensors, it's necessary to select the appropriate communication protocol to program the new sensors. These sensors then use this protocol to communicate with the vehicle's computer or tire pressure receiver. The database also contains various communication protocol corresponding to different vehicle data. To replace tire sensors, operate a mobile device, choose the vehicle brand, year, and model, or enter the Vehicle Brand Identification Code (HSN) and Vehicle Model Identification Code (TSN) (HSN and TSN are used only in Germany), to select the right communication protocol from the many stored in the mobile device, and then program the new tire sensors with it. After re-selecting the same brand, year, and model on the handheld device, or re-entering the HSN and TSN, various methods stored in the device for initiating the car computer's learning mode can be accessed. A suitable method for the specific vehicle is chosen, displaying text instructions on the device's small screen. The operator then manipulates various components of the vehicle according to these instructions, thereby enabling the car computer to enter a state where it can learn new codes (specifically, to learn the identification codes of the tire sensors). Consequently, the car computer is able to receive and store the identification codes of new tire sensors, which use the appropriate communication protocol to transmit tire pressure signals (containing the sensor ID) to the car computer for recognition. Thus, the process of twice selecting the vehicle's brand, year, model, or entering HSN and TSN, is time-consuming. The small display screen of the handheld device also poses challenges in viewing and operation, potentially leading operators to choose incorrect communication protocol, thus prolonging the programming process. Errors in installation could result in repeat visits to the service center, diminishing the customer's trust in the operator's expertise.

Additionally, data such as the brand, year, and model entered on the handheld mobile device cannot be saved. Thus, when the same vehicle returns to the shop for tire sensor replacement, it is necessary to re-enter the brand, year, and model. Furthermore, after entering these details on the handheld mobile device, the technician might not immediately program the communication protocol. For instance, they might navigate to another page to check different installation information. Consequently, the data entered on the handheld mobile device may be lost due to the use of other functions. Therefore, there is a need to save the entered data on the handheld mobile device after inputting the brand, year, and model. Addressing this issue is one of the objectives of this invention.

In light of these issues, the inventor, leveraging extensive experience in related product manufacturing and design, has developed this practical and innovative solution.

### SUMMARY

This invention aims to solve technical problems in existing technology by providing a system for setting up tire sensor communication protocol. It includes an electronic device connected to a first database, which displays a link diagram after inputting vehicle data, and a handheld mobile device connected to a second database. After using the handheld mobile device to scan the link diagram, the handheld mobile device retrieves a communication protocol from either the first or second database, and the communication protocol is used to program a corresponding tire sensor.

The link diagram includes a communication protocol command and a communication protocol path. The handheld mobile device searches for the specified protocol in the second database based on the communication protocol command and downloads the specified protocol from the first database based on the communication protocol path if the specified protocol is not found.

The electronic device is connected to a network server, with the first database being a cloud database on this server. The electronic device can be a desktop computer, laptop, tablet, or smartphone.

Vehicle data includes one of the following: vehicle brand data, brand identification code (HSN), or model identification code (TSN). Brand data covers brand (maker), year, and model (MMY).

The handheld mobile device has an operating module connected to a camera module or an infrared module, which captures the link diagram and the operating module selects the corresponding communication protocol.

The handheld mobile device features a low-frequency transceiver to program the tire sensor with the communication protocol.

The handheld mobile device has a first Bluetooth module, and the tire sensor includes a storage module and a second Bluetooth module. The mobile device uses the first Bluetooth to communicate with the second Bluetooth of the tire sensor to store the protocol in its storage module.

After programming, the tire sensor sends back the protocol and an ID code to the mobile device, which then compares the returned ID code with the original one programmed into the tire sensor to verify successful programming. If the two identification codes are consistent, indicating successful programming, and if the two identification codes are not consistent, indicating failed programming.

The technical problem addressed by this invention is to overcome deficiencies in existing technology by providing a system for setting tire sensor communication protocol. This includes: a tire sensor comprising a control module and a sensing module, a transmission module, and a power module electrically connected to the control module. The power module powers the tire sensor. The control module controls the sensing module to sense tire information and transmits this information externally via the transmission module, which also receives external signals. An electronic device, connected to a first database, displays a link diagram upon inputting vehicle data into the electronic device. A handheld mobile device, connected to a second database, scans this link diagram and retrieves a communication protocol from either the first or second database. This protocol is used to connect to the transmission module of the tire sensor for programming.

The electronic device, based on the vehicle data entered, displays a code learning process diagram based on the vehicle data, and the code learning process diagram includes one of the following: on-board diagnostics (OBD) code learning, automatic code learning, tool-triggered code learning, or deflation-triggered code learning.

The electronic device connects to a printer, and the handheld mobile device, after scanning the link diagram, triggers the printer to automatically print the code learning process diagram.

The sensing module includes a pressure sensor, at least one accelerometer, a temperature sensor, or a magnetic sensor. The handheld mobile device uses the communication protocol to connect to the tire sensor and receives tire information including tire pressure, acceleration, temperature, or magnetic signals from the transmission module. This tire information is then relayed back to the electronic device by the handheld mobile device.

The invention also addresses the technical problems in existing technology by providing a system for setting up communication protocol or identification codes for tire sensors. This system includes a first tire sensor with an identification code and a second tire sensor with a storage device. The electronic device, connected to a first database, displays a link diagram upon entering vehicle data. A handheld mobile device connected to a second database retrieves a communication protocol from either the first or second database upon scanning the link diagram. This protocol is used to connect the first and second tire sensors. The handheld device, equipped with either a wireless trigger module or a human-machine interface, transmits the identification code in one of two ways: (1) The wireless trigger module wirelessly triggers the first tire sensor to obtain its identification code and then connects to the second tire sensor to transmit this code; (2) The human-machine interface accepts a manual trigger or setting to read the identification code input for the first tire sensor and then transmits it to the second tire sensor.

The invention resolves technical problems in existing technology by providing a system for setting up a tire sensor communication protocol. It includes a tire sensor with at least one sensing module and a first transmission module, and the sensing module detects tire information. An electronic device, connected to a first database and a receiving module, searches the first database upon entering vehicle data, subsequently generating and displaying a link diagram. A handheld mobile device, with a second database and a second transmission module, retrieves a communication protocol from either the first database or the second database after scanning the link diagram. This communication protocol is used to connect the corresponding tire sensor, and tire information is transmitted via both the first and second transmission modules, with the second transmission module connecting to the receiving module to transfer this tire information to the electronic device.

The electronic device features a first input interface, while the handheld mobile device has a second input interface. Vehicle information is entered through either the first input interface or the second input interface, and combined with tire information to create customer service history data in the electronic device.

The first and second input interfaces include touch screens, as well as external keyboards or mice.

The invention provides steps for setting a tire sensor communication protocol: a first device inputs vehicle data and searches an internal or external database to generate a specific communication protocol command; this communication protocol command forms a link diagram, displayed on the first device; a second device scans this link diagram and executes the communication protocol command; and according to the communication protocol command, the second device searches an internal or external database for a communication protocol and uses it to program a tire sensor.

The primary objective of this invention is to overcome the drawbacks of a small screen and prone-to-error input on a handheld mobile device by displaying a link diagram on an electronic device, which is then scanned by the handheld mobile device. This eliminates the need for manual vehicle data entry on the handheld mobile device and simplifies the process of selecting appropriate communication protocol for various vehicle models. This method is particularly advantageous in settings such as ID COPY, OBD learning code, automatic learning code, tool-triggered learning code, and deflation learning code.

Another main objective is to allow for quick preparation of a vehicle's computer to receive tire sensor IDs. This is facilitated by a code learning process diagram provided by the electronic device after inputting vehicle data, thus simplifying the operation as compared to navigating complex options on the handheld device or phone for specific vehicle model to find out that its vehicle computer can enter into the mode of the code learning.

Other objectives, advantages, and novel features of the invention will become more apparent from the detailed description and accompanying drawings.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram (I) of the structure for setting the tire sensor communication protocol;

FIG. 2 is a schematic diagram (II) of the structure for setting the tire sensor communication protocol;

FIG. 3 is a schematic diagram of the structure for the low-frequency transceiver communicates with the tire sensor;

FIG. 4 is a schematic diagram of the structure for the bluetooth transmission communicates with the tire sensor;

FIG. 5 is a schematic diagram of the structure for tire information collection from the tire sensor;

FIG. 6 is a schematic diagram of the structure for generating the code learning process diagram by the electronic device;

FIG. 7 is a schematic diagram of the OBD code learning process;

FIG. 8 is a schematic diagram of the automatic code learning process;

FIG. 9 is a schematic diagram of the tool-triggered code learning process;

FIG. 10 is a schematic diagram for displaying the OBD code learning process by the code learning process diagram;

FIG. 11 is a schematic diagram for displaying the tool-triggered code learning process by the code learning process diagram;

FIG. 12 is a schematic diagram (I) of the structure for setting the tire sensor identification code;

FIG. 13 is a schematic diagram (II) of the structure for setting the tire sensor identification code;

FIG. 14 is a schematic diagram (III) of the structure for setting the tire sensor communication protocol;

FIG. 15 is a schematic diagram for selecting the built-in communication protocol of the tire sensor using a link diagram;

FIG. 16 is a schematic diagram for the binding of vehicle information to the link diagram;

FIG. 17 is a flowchart of the operational steps for setting the tire sensor communication protocol;

FIG. 18 is a schematic diagram of the structure for setting both the tire sensor communication protocol and identification code; and

FIG. 19 is a schematic diagram for the scanning of the link diagram.

### DETAILED DESCRIPTION

To provide a deeper understanding of the invention's objectives, features, and benefits, the following explanation is given in conjunction with the above brief description of the drawings.

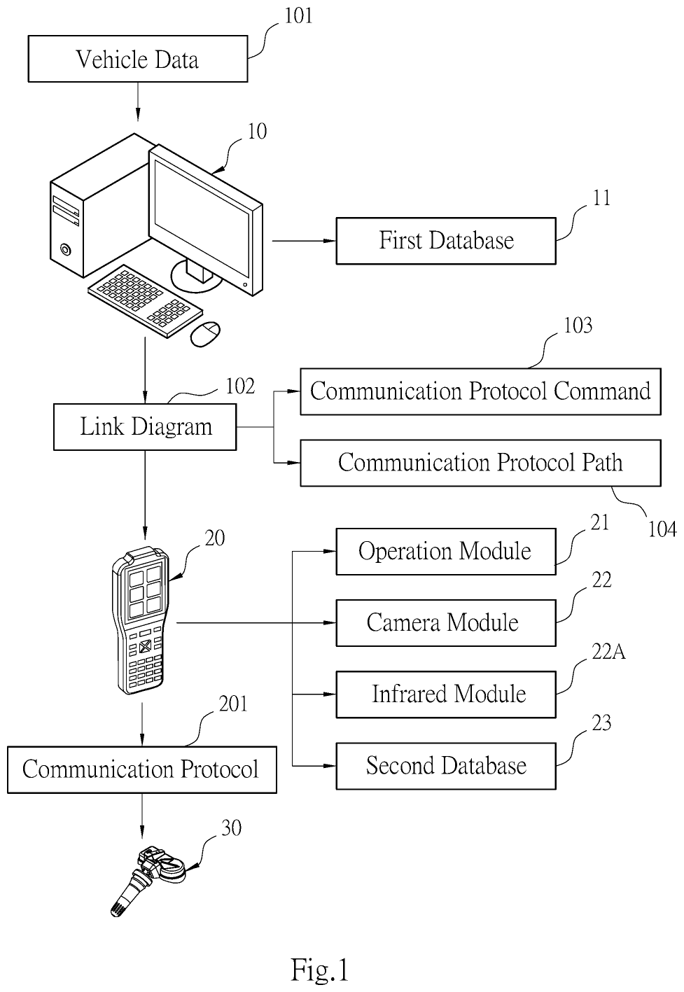

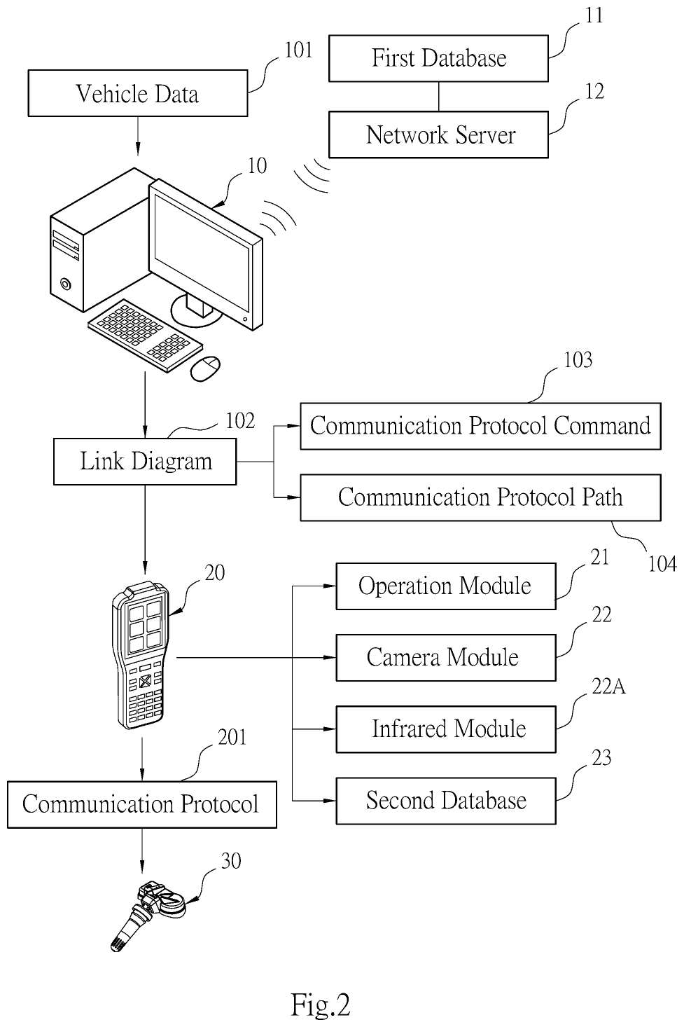

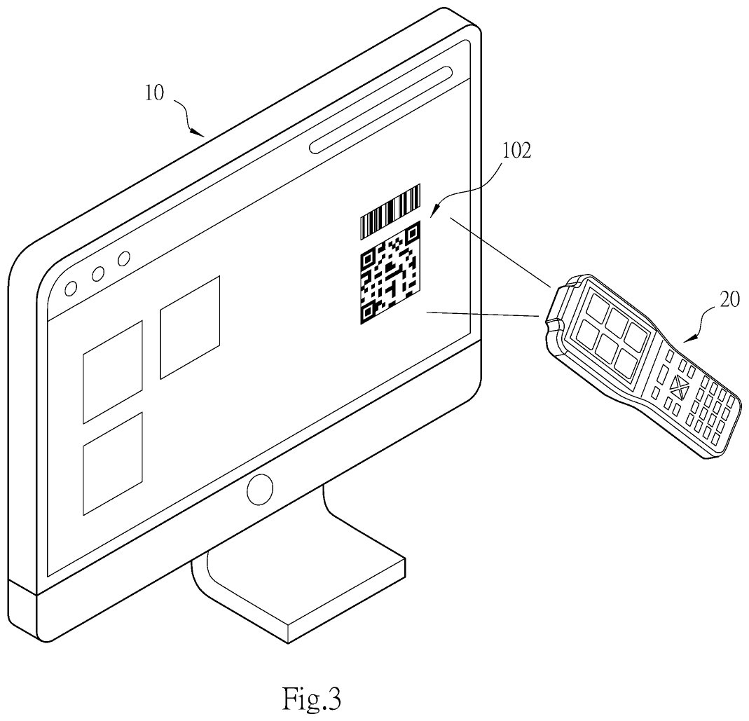

As depicted in FIGS. 1, 2, and 3, the invention relates to a system for configuring a tire sensor communication protocol or identification code. This system comprises an electronic device (10) and a handheld mobile device (20). The electronic device (10) is linked to a first database (11), serving as its internal storage or connecting to a network server (12), where the first database (11) could be a cloud-based storage on the network server (12). The electronic device (10), which can be a desktop computer, laptop, tablet, or smartphone, is equipped with electronic input and display functionalities. Upon entering vehicle data (101) into the electronic device (10), a link diagram (102) is displayed on the electronic device (10). The way of entering vehicle data includes and not limits to a keyboard entry, touching-interface entry, mouse entry, voice entry or image entry, and so on.

This link diagram (102), possibly a barcode or QR code, is retrievable or analytically generated from the first database (11) and this link diagram (102) includes a communication protocol command (103) and a communication protocol path (104). The vehicle data (101) comprises either the vehicle brand data, HSN, or TSN, with HSN corresponding to the brand, and TSN to the year and model. The vehicle brand data consists of the brand (manufacturer or maker), year, and model, and three of them collectively known as MMY. The handheld mobile device (20) connects to an operation module (21), which is linked to either a camera module (22) or an infrared module (22A). These modules capture the link diagram (102), and the operation module (21) selects an appropriate communication protocol (201). The camera module (22) or infrared module (22A) can scan or photograph one-dimensional barcodes, two-dimensional barcodes (like QR codes), or numerical identifiers on tire sidewalls. The tire sidewall ID number, such as the tire's unique ID, can be identified through image recognition software. Additionally, the handheld mobile device (20) connects to a second database (23). After scanning the link diagram (102) with the camera module (22) or infrared module (22A), the handheld mobile device (20) searches for the specified communication protocol (201) in the second database (23) based on the communication protocol command (103). If the specified communication protocol (201) is not found, it can be downloaded from the first database (11) using the communication protocol path (104). This process automatically retrieves the communication protocol (201) from either the first or second database (23), eliminating the need to input vehicle data (101) on the handheld mobile device (20). This approach overcomes the challenges of small screens and potential input errors, making the selection of different communication protocol (201) for various vehicle models more convenient. The handheld mobile device (20) may be a smartphone or a tire sensor configuration tool provided by a tire sensor manufacturer.

Further elaborating on its effectiveness, the electronic device (10) is linked to the first database (11), while the handheld mobile device (20) is connected to the second database (23). Upon inputting vehicle data (101) such as brand, year, and model (collectively referred to as MMY) into the electronic device (10), the handheld mobile device (20) automatically retrieves the communication protocol (201) from either the first database (11) or the second database (23). Both databases are capable of automatically updating via the internet in accordance with the increasing range of vehicle models, thus generating new link diagram (102) that correspond to the new communication protocol (201), ensuring that appropriate or up-to-date link diagram (102) is always available.

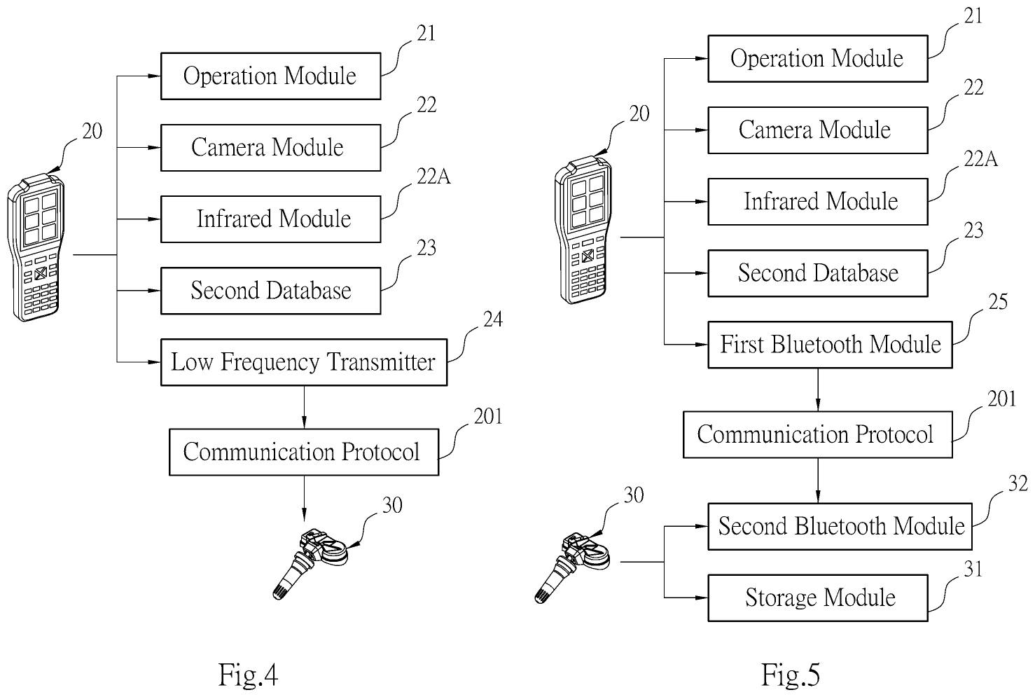

As illustrated in FIGS. 4 and 5, the communication protocol (201) in the handheld mobile device (20) is used for communication and programming of the corresponding tire sensor (30). This can be accomplished through either a low-frequency connection or a bluetooth connection: 1) The handheld mobile device (20) is equipped with a low-frequency transmitter (24), capable of emitting low-frequency (LF, 125 KHz) signals, to program the tire sensor (30) with the communication protocol (201). 2) The handheld mobile device (20) contains a first bluetooth module (25), and the tire sensor (30) is equipped with a storage module (31) and a second bluetooth module (32). The handheld device (20) uses the first Bluetooth module (25) to communicate with the second Bluetooth module (32) to store the communication protocol (201) in the storage module (31) of the tire sensor (30). The handheld mobile device (20) is principally a portable tool, independent of the vehicle, serving as a tire sensor setting tool manufactured or sold by tire sensor manufacturers, and the handheld mobile device (20) can be conveniently carried and used at any predetermined location.

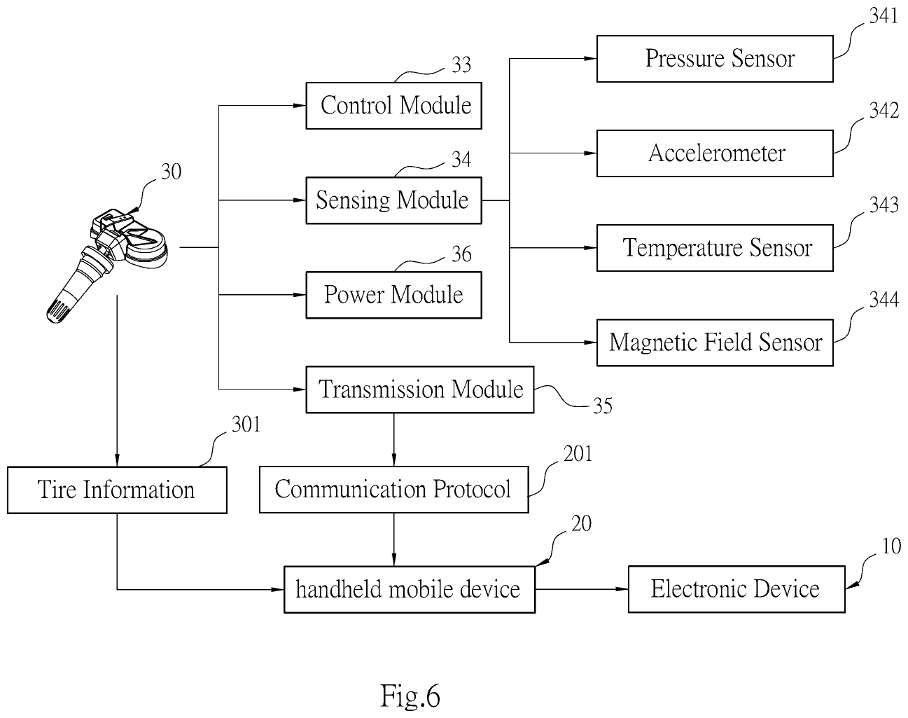

Referencing FIG. 6, the tire sensor (30) comprises a control module (33) electrically connected to a sensing module (34), a transmission module (35), and a power module (36). The power module (36) powers the tire sensor (30). The control module (33) directs the sensing module (34) to detect tire information (301), and the transmission module (35) to externally transmit this tire information (301) as well as receive external signals. The sensing module (34) includes a pressure sensor (341), at least one accelerometer (342), a temperature sensor (343), or a magnetic field sensor (344). The handheld mobile device (20) uses the communication protocol (201) to connect to the tire sensor (30), receiving tire information (301) such as tire pressure, acceleration, temperature, or magnetic signals from the transmission module (35). This tire information (301) is then transmitted back to the electronic device (10) via the handheld mobile device (20) for storage and analysis in the first database (11), facilitating early detection of tire calibration and replacement needs, and also enabling big data analysis of the tire information (301) to enhance the tire sensor (30).

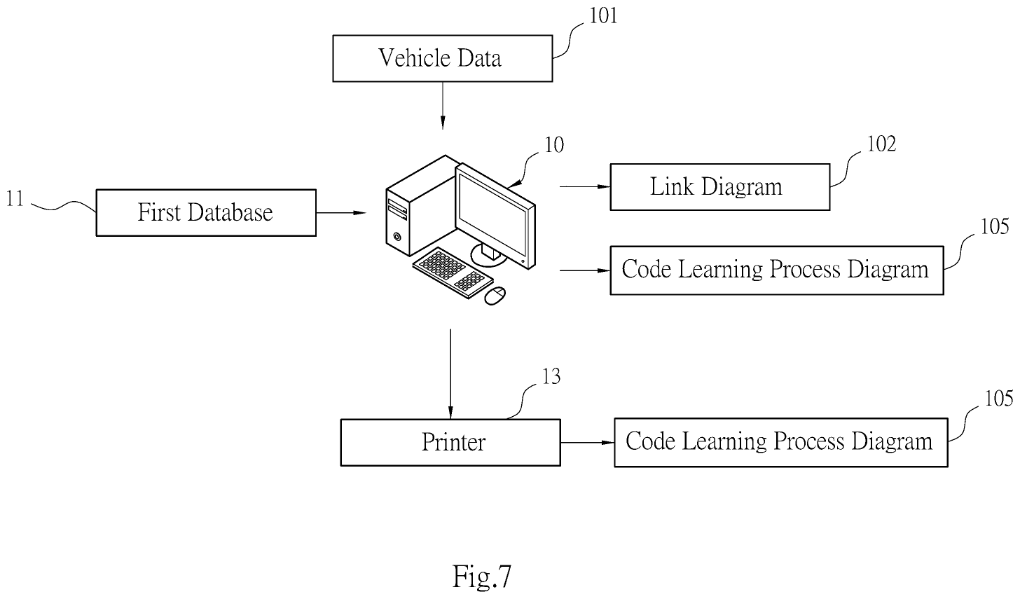

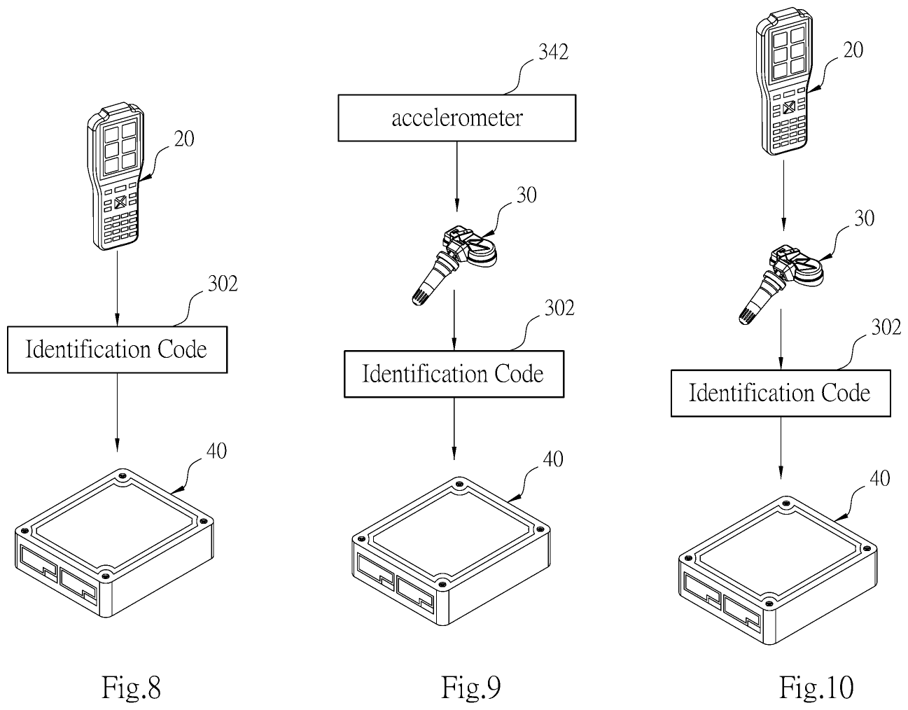

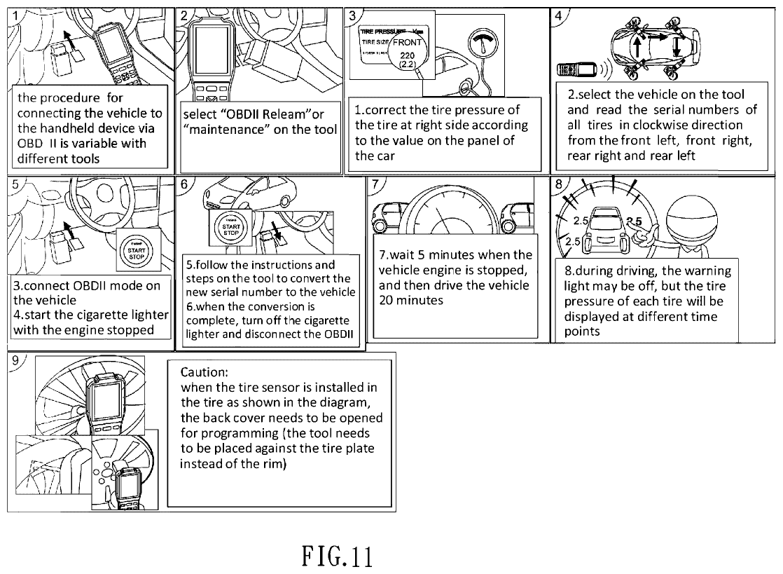

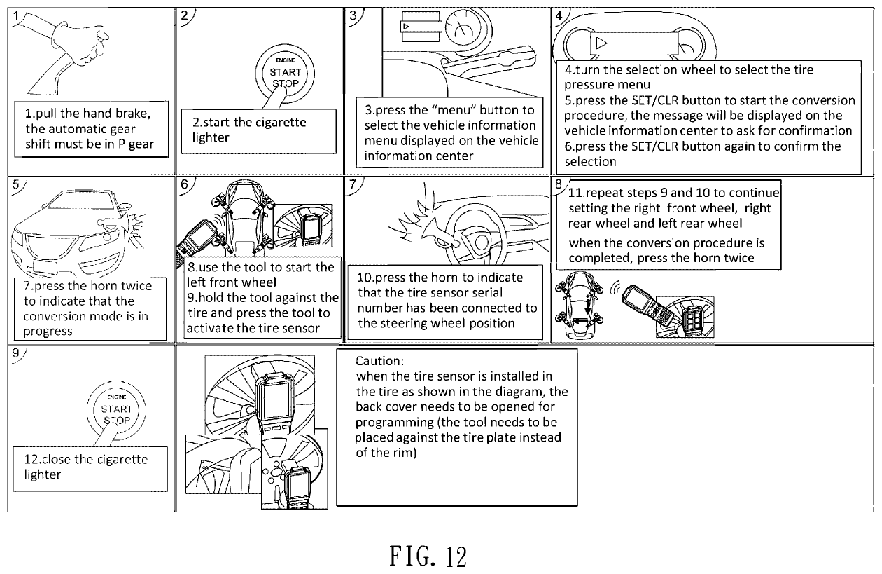

As shown in FIG. 7, after the electronic device (10) inputs the vehicle data (101), it also displays a code learning process diagram (105). This diagram includes one of the following: on-board diagnostics (OBD) code learning, automatic code learning, tool-triggered code learning, or deflation-triggered code learning. As shown in FIG. 8, the on-board diagnostics (OBD) code learning means the handheld mobile device (20) connecting via cable to the vehicle's OBD, thereby transmitting an identification code (302) to the vehicle computer (40). As illustrated in FIG. 9, the automatic code learning means that without the handheld mobile device (20), the vehicle, once started and driven for a certain duration, allows the vehicle computer (40) to automatically receive the identification code (302) from the tire sensor (30). This is because the tire sensor (30) contains an accelerometer (342), which, when the tire rotates, detects acceleration in various directions, triggering the tire sensor (30) to transmit the identification code (302) to the vehicle computer (40). As depicted in FIG. 10, the tool-triggered code learning refers to the handheld mobile device (20) wirelessly sending a signal to wirelessly trigger the tire sensor (30), which then sends the identification code (302) to the vehicle computer (40). The deflation-triggered code learning means that when the tire sensor (30) detects a reduction in tire pressure, it is triggered to send the identification code (302) to the vehicle computer (40). Specifically, the invention requires that the first database (11) has pre-stored various code learning process diagrams and retrieval data. Once the brand, year, model, and/or (HSN)/(TSN) of the vehicle are entered into the electronic device (10), the link diagram (102) and the appropriate code learning process diagram (105) are obtained. The code learning process (the process of learning the tire sensor identification code) is meant to put the vehicle computer (40) into learning mode, where it can learn the identification code (302) of the tire sensor (30). In this mode, the vehicle computer (40) can receive the identification code (302) from the tire sensor (30), the handheld mobile device (20), or other devices. Consequently, operators can quickly use the code learning process diagram (105) to put the vehicle computer (40) into a state where it can receive the identification code (302) of the tire sensor (30). There's no need to operate more complex options on the handheld mobile device (20) or smartphone to find out how to put the specific vehicle type into learning mode of the vehicle computer (40). The code learning process diagram (105), as shown in FIG. 11, is an example of an OBD code learning process, and as shown in FIG. 12, is an example of a tool-triggered code learning process. Additionally, the electronic device (10) is connected to a printer (13). After the handheld mobile device (20) scans the link diagram (102), the printer (13) automatically prints the code learning process diagram (105), thereby assisting operators in carrying and consulting the code learning process diagram (105) for connecting to the vehicle computer (40).

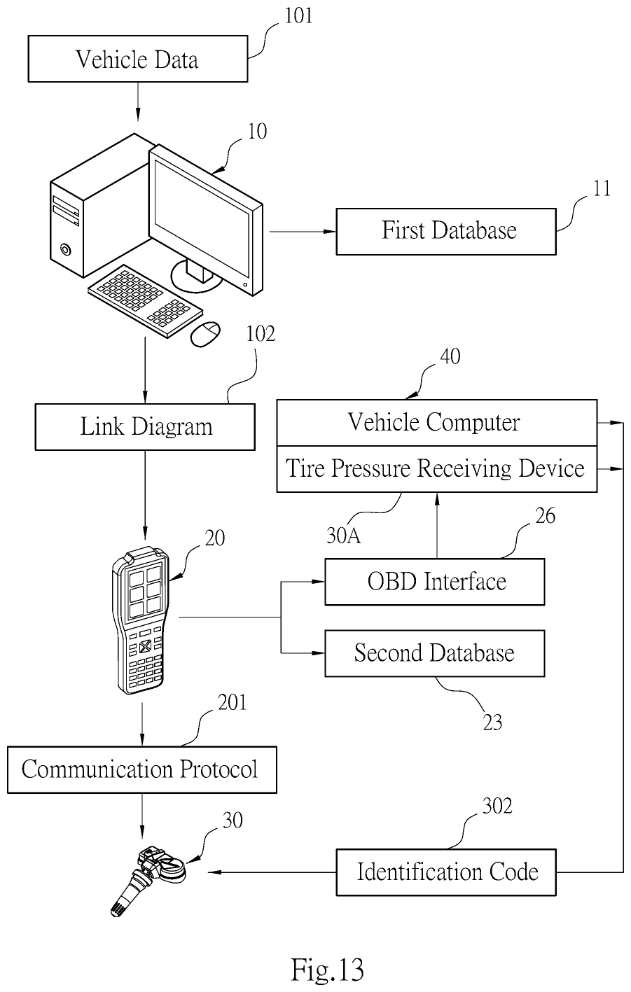

Regarding the OBD code learning process shown in FIG. 13, the vehicle computer (40) or a tire pressure receiving device (30A) has an identification code (302) used to determine which tire sensor it is connected to. The tire pressure receiving device (30A) acts as a receiver when the vehicle computer (40) cannot directly connect to the tire sensor. An electronic device (10) is connected to a first database (11) and displays a link diagram (102) upon entering vehicle data (101) into the electronic device (10). A handheld mobile device (20) equipped with a second database (23) and an OBD interface (26), and the OBD interface (26) connects the handheld mobile device (20) to the vehicle computer (40) or the tire pressure receiving device (30A), and the handheld mobile devices (20) scans the link diagram (102), retrieving a communication protocol (201) from either the first (11) or second database (23). This communication protocol (201) is then used for communication between the OBD interface (26) and the vehicle computer (40) or tire pressure receiving device (30A), transmitting the identification code (302) to the the handheld device (20). Furthermore, when the handheld device (20) connects to a tire sensor (30) (new replacement) for programming, it simultaneously transmits the identification code (302) to the tire sensor (30).

The identification code (302), also known as an ID, which is an own identification code of the tire sensor (30), and the identification code (302) is the unique code for each tire sensor (30), and the identification code (302) allows the vehicle computer (40) to recognize each sensor when the vehicle computer (40) receives a tire pressure signal which contains the identification code (302) from each sensor. This code can be a combination of numbers, codes, encodings, or symbols, and is utilized for identifying the tire sensor (30).

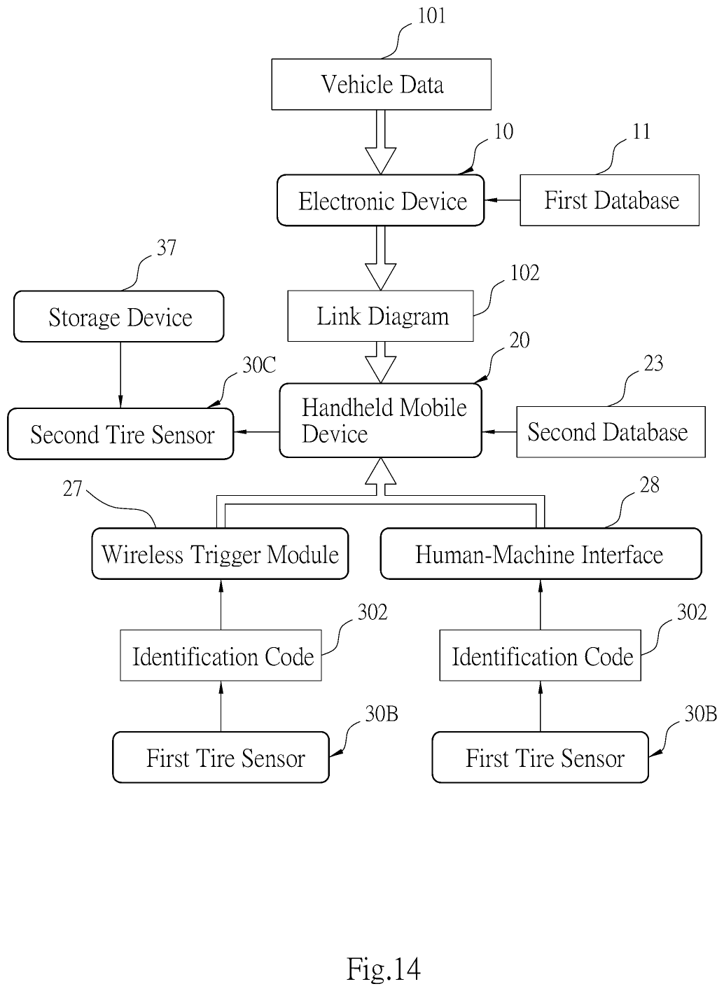

Another embodiment of the invention, as illustrated in FIG. 14, involves a system for setting a tire sensor communication protocol or identification code. This system includes a first tire sensor (30B) with an identification code (302), a second tire sensor (30C) with a storage device (37), and an electronic device (10) linked to a first database (11). After inputting vehicle data (101) to the electronic device (10), it displays a link diagram, and scanning the link diagram (102) using a handheld mobile device (20) connected to a second database (23), a communication protocol (201) is retrieved from the first (11) or the second database (23). This communication protocol (201) is used to connect both the first sensor (30B) and second tire sensor (30C). The handheld mobile device (20) transmits the identification code (302) either through a wireless trigger module (27) or a human-machine interface (28).

The handheld mobile device transmits the identification code in one of the following ways: (1) the wireless trigger module (27) wirelessly activates the first tire sensor (30B) to obtain the identification code (302), and the handheld mobile device (20) connects to the second tire sensor (30C) and transmits the identification code to the second tire sensor (30C); (2) the human-machine interface (28) accepts a manual trigger or setting to enter the identification code (302) to the handheld mobile device (20), and the handheld mobile device (20) reads and transmits the identification code (302) to the second tire sensor (30C). To conclude, the invention provides a way to automatically get the communication protocol and finish the setup of the ID COPY, and the ID COPY is defined as obtaining the identification code from the old first tire sensor (30B) and copying the same identification code to the new second tire sensor (30C) for use. Thus, the new second tire sensor (30C) uses the identification code of the old first tire sensor (30B) to communicate with other electronic devices.

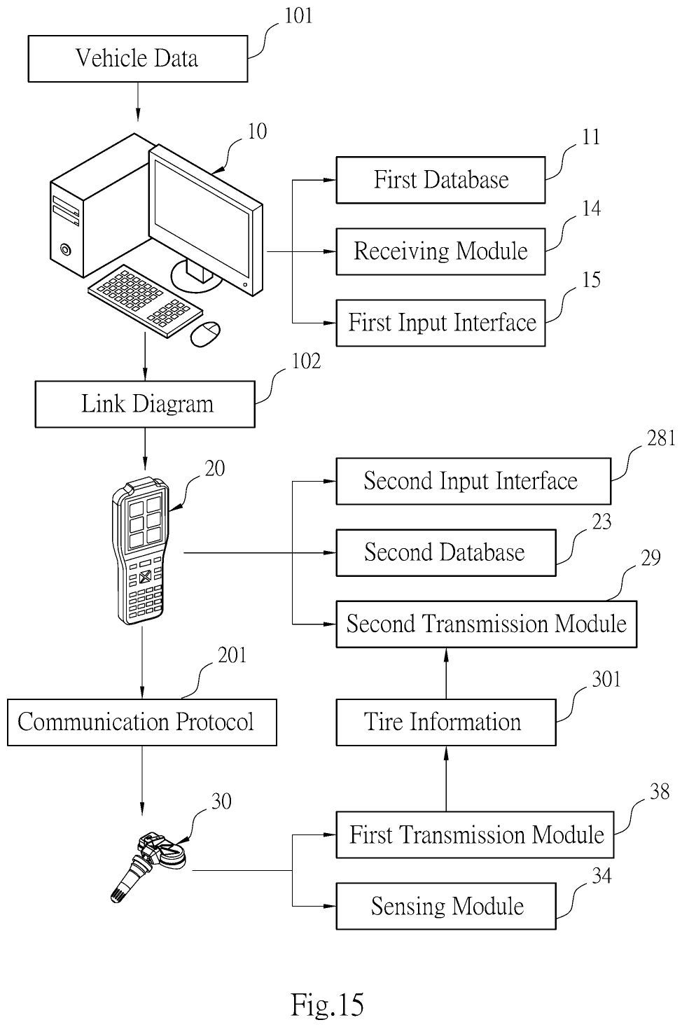

Another concrete embodiment of this invention, as shown in FIG. 15, is a system for configuring communication protocol for tire sensors. It includes an electronic device (10), a handheld mobile device (20), and a tire sensor (30). The tire sensor (30) comprises at least one detection sensing module (34) and a first transmission module 38. The detection sensing module (34) detects tire information (301). The electronic device (10), linked to a first database (11) and a receiving module (14), searches the first database (11) upon entering vehicle data (101) into the electronic device (10), thus producing and displaying a link diagram (102) on the electronic device (10). The handheld mobile device (20), linked to a second database (23) and a second transmission module (29), acquires a communication protocol (201) from either the first database (11) or the second database (23) after scanning the link diagram (102) by the handheld mobile device (20). This communication protocol (201) connects to the corresponding tire sensor (30). The first transmission module (38) and the second transmission module (29) transmit the tire information (301), which includes at least tire pressure data and can also contain acceleration, temperature, or magnetic field signals. Furthermore, the second transmission module (29) connects to the receiving module (14) to transfer the tire information (301) to the electronic device (10), thereby efficiently collecting, analyzing, and storing the tire information (301). The electronic device (10) features a first input interface (15), while the handheld mobile device (20) is equipped with a second input interface (281). Vehicle information, such as license plate or VIN code, is entered through either the first input interface (15) or the second input interface (281). This information, combined with tire information (301) in the electronic device (10), creates customer service history records. This helps in understanding the owner's maintenance, consumable replacement, and vehicle usage. Both the first input interface (15) and the second input interface (281) can be touch screens, external keyboards, or external mice.

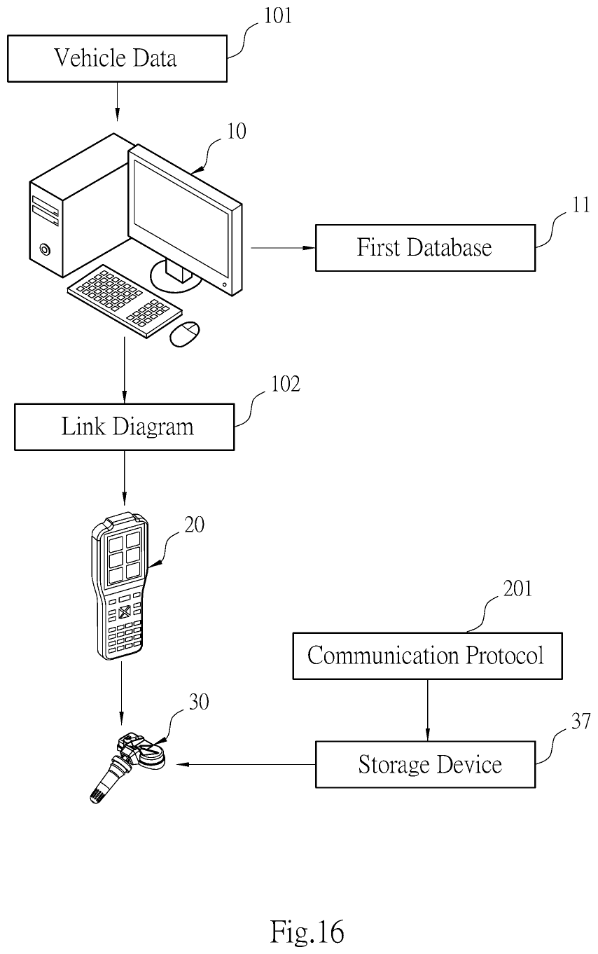

In yet another specific embodiment of the invention, as shown in FIG. 16, a system for setting a tire sensor communication protocol is provided. This system includes: a tire sensor (30) with a storage device (37), which stores multiple communication protocol (201). An electronic device (10) is connected to a first database (11). Upon entering vehicle data (101), it searches the first database (11) to display a link diagram (102) on the electronic device (10). This link diagram (102) includes a communication protocol command (103). A handheld mobile device (20), after scanning the link diagram (102), acquires the communication protocol command (103). The handheld device (20) then sends the communication protocol command (103) to the tire sensor (30), enabling the tire sensor (30) to select the corresponding communication protocol (201) in the storage device (37) based on the communication protocol command (103). This connection and setup of the tire sensor (30) provides another method for setting the tire sensor (30). The above content highlights that the link diagram (102) mentioned possesses a unique characteristic. Specifically, the electronic device (10) only generates and displays a single linked diagram (102). Whenever the same vehicle data (101) is entered, the same linked diagram (102) will always appear. It also ensures that multiple linked diagram (102) are not displayed simultaneously, eliminating the need for operators to discern which linked diagram (102) to use. This avoids scanning or photographing an incorrect linked diagram (102), thereby facilitating a more intuitive programming process.

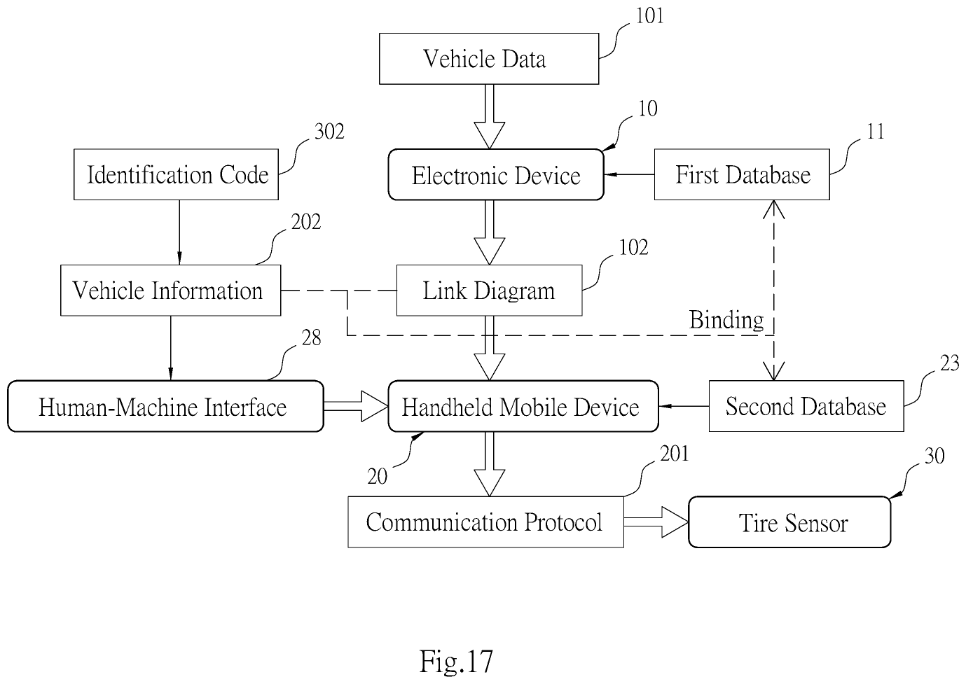

In another embodiment of the invention, as illustrated in FIG. 17, a system for setting a tire sensor communication protocol is disclosed. This system comprises: an electronic device (10) connected to a first database (11). Upon entering vehicle data (101), the first database (11) is searched to generate and display a link diagram (102). A handheld mobile device (20) is connected to a second database (23) and a human-machine interface (28). This human-machine interface (28) accepts a manual trigger or setting to establish vehicle information (202), including license plate numbers or VIN codes. After scanning the link diagram (102) by the handheld mobile device (20), a communication protocol (201) is obtained from either the first database (11) or second (23) database. This protocol (201) is then used to program the tire sensor (30). Upon successful programming, the link diagram (102) and vehicle information (202) are bound together. This ensures that during subsequent replacements and programming of the tire sensor (30), the communication protocol (201) can be directly designated and used through a simple input condition to form the link diagram (102).

Further elaborating, refer to FIG. 17, the link diagram (102), once bound with the vehicle information (202), is uploaded and stored in either the first database (11) or the second database (23). When replacing the tire sensor (30) for the same vehicle again, one can choose to enter either the license plate number or the VIN code of the vehicle information (202) into the electronic device (10) to generate the link diagram (102). Alternatively, one can choose to enter either the license plate number or the VIN code of the vehicle information (202) into the handheld mobile device (20), which directly designates the communication protocol (201), thereby eliminating the need to re-enter MMY or (HSN)/(TSN) into either the electronic device (10) or the handheld mobile device (20), offering ease of operation during installation. Furthermore, the vehicle information (202) also includes an identification code (302) of the tire sensor. The human-machine interface (28) accepts a manual trigger or setting to enter identification code (302) into the handheld mobile device (20), subsequently allowing the handheld mobile device (20) to read the entered identification code (302), and then transmit this identification code (302) to the tire sensor (30) to be replaced.

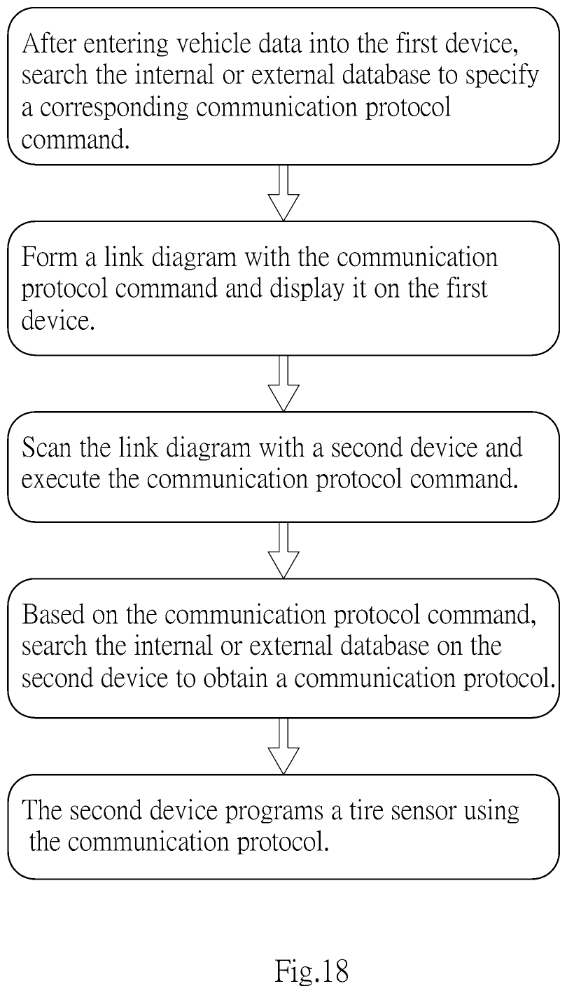

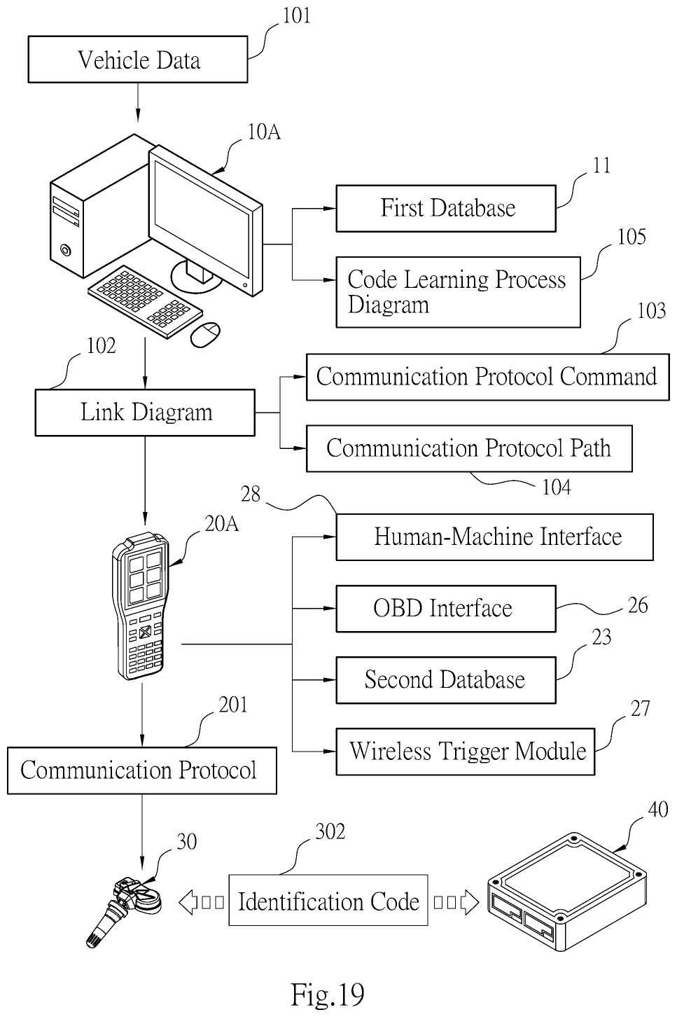

A method for setting a tire sensor communication protocol, as demonstrated in FIGS. 18 and 19, comprises the following steps:

Step One: Input vehicle data (101) into a first device (10A). Search an internal or external database to designate a corresponding communication protocol command (103), wherein the internal database refers to the memory storage of the first device (10A) and the external database to a cloud database connected externally;

Step Two: Form a link diagram (102) with the communication protocol command (103), displayed on the first device (10A). The device, based on vehicle data (101), searches internal or external databases to retrieve and display a code learning process diagram (105). This diagram assists in operating a vehicle computer (40) to interpret the tire sensor (30);

Step Three: Use a second device (20A) to scan the link diagram (102) and execute the communication protocol command (103). The link diagram (102) can be a two-dimensional barcode (e.g., QR code), and the communication protocol command (103) can be a URL or a string of executable code;

Step Four: According to the communication protocol command 103, the second device (20A) searches for a communication protocol (201) in its internal or external database. The link diagram 102 includes a communication protocol path (104). The second device (20A) searches the internal database for the specified communication protocol (201) based on the communication protocol command (103). If the specified communication protocol (201) is not found, it downloads from the external database using the communication protocol path (104). The external database is set up in a cloud database on a network server 12; and

Step Five: The second device (20A) programs the tire sensor (30) with the communication protocol (201). Upon successful programming, the tire sensor (30) sends a confirmation signal to the second device (20A), thus completing the steps of setting the communication protocol (201) and programming the tire sensor (30).

A method for setting tire sensor identification codes, comprising:

Method One: the second device (20A) has an OBD interface (26), connecting to a vehicle computer (40). After scanning the link diagram (102) by the second device (20A), it retrieves a communication protocol (201) from the internal or the external database. Using this communication protocol (201), the second device (20A) connects through the OBD interface (26) to the vehicle computer (40) to receive an identification code (302), and then the second device (20A) synchronously transmits this identification code (302) to the tire sensor (30) during programming this communication protocol (201) to the tire sensor (30).

Method Two: The second device (20A) includes a wireless trigger module (27). It uses this wireless trigger module (27) to trigger an old tire sensor (30) to obtain an identification code (302). When programming a new tire sensor (30) with the communication protocol (201), the second device (20A) synchronously transmits this identification code (302) to the new tire sensor (30).

Method Three: The second device (20A) is equipped with a human-machine interface (28). This human-machine interface (28) accepts a manual trigger or setting to enter an identification code (302) into the second device (20A), allowing the second device (20A) to read the entered identification code (302), which is then transmitted to the tire sensor (30).

The invention further incorporates a programming confirmation mechanism. This mechanism operates in the second device (20A) (handheld mobile device) after programming the tire sensor (30). Post-programming, the tire sensor (30) transmits the communication protocol (201) and an identification code (302) back to the second device (20A). At this point, the second device (20A) compares the consistency of the returned identification code with an original identification code programmed into the tire sensor. If the two identification codes are consistent, it indicates a successful programming, and if the two identification codes are not consistent, it signifies a failed programming. This enables the operator to immediately know the programming result and, in case of failure, to repeat the programming action or modify the operation method.

The above description is merely a preferred embodiment of the invention and should not limit its scope. Any equivalent variations and modifications made within the claims of this invention are still within the scope of the patent.

What is claimed is:

1. A system for setting a tire sensor communication protocol, comprising:
an electronic device connected to a first database, displaying a link diagram upon inputting vehicle data; and
a handheld mobile device connected to a second database, retrieving a communication protocol from either the first or second database after scanning the link diagram, and the communication protocol used for programming a corresponding tire sensor.

2. The system of claim 1, wherein the link diagram includes a communication protocol command and a communication protocol path, the handheld mobile device searches the second database for the specified communication protocol based on the communication protocol command, and if the specified communication protocol is not found, downloading the specified communication protocol from the first database using the communication protocol path.

3. The system of claim 1, wherein the electronic device is connected to a network server, and the first database is a cloud database located on the network server, and the electronic device is a desktop computer, a laptop, a tablet, or a smartphone.

4. The system of claim 1, wherein the handheld mobile device is connected to an operation module, and the operation module is connected to either a camera module or an infrared module, when the camera module or the infrared module captures the link diagram, and the operation module selects the corresponding communication protocol.

5. The system of claim 1, wherein the handheld mobile device includes a low-frequency transceiver, the handheld mobile device uses the low-frequency transceiver to program the communication protocol into the tire sensor.

6. The system of claim 1, wherein the handheld mobile device includes a first bluetooth module, and the tire sensor includes a storage module and a second bluetooth module, and the first bluetooth module of the handheld mobile device communicates with the second bluetooth module to store the communication protocol in the storage module of the tire sensor.

7. The system of claim 1, wherein, after programming the communication protocol into the tire sensor, the tire sensor sends back the communication protocol and an identification code to the handheld mobile device, and the handheld mobile device compares the consistency of the returned identification code with an original identification code programmed into the tire sensor, if the two identification codes are consistent, indicating successful programming, and if the two identification codes are not consistent, indicating failed programming.

8. A system for setting a tire sensor communication protocol, comprising:
a tire sensor comprising a control module, and the control module electrically connected to a sensing module, a transmission module and a power module, and the power module provides power to the tire sensor, and the control module controls the sensing module to detect tire information, which is transmitted externally by the transmission module, and the transmission module receives an external signal;
an electronic device, which is connected to a first database, and the electronic device displays a link diagram upon inputting vehicle data; and
a handheld mobile device, which is connected to a second database, and the handheld mobile device retrieves a communication protocol from either the first or second database after scanning the link diagram, and the communication protocol is used to connect to the transmission module of the tire sensor, and the communication protocol is used for programming the tire sensor.

9. The system of claim 8, wherein the electronic device displays a code learning process diagram based on the vehicle data, and the code learning process diagram includes one of the following: on-board diagnostics (OBD) code learning, automatic code learning, tool-triggered code learning, or deflation-triggered code learning.

10. The system of claim 8, wherein the sensing module includes a pressure sensor, at least one accelerometer, a temperature sensor, or a magnetic field sensor, and the handheld mobile device uses the communication protocol to connect the tire sensor, and the handheld mobile device receives said tire information from the transmission module, and said tire information includes tire pressure, acceleration, tire temperature, or a magnetic field signal, and the handheld mobile device sends back said tire information to the electronic device.

11. A system for setting a tire sensor communication protocol or identification code, comprising:
a first tire sensor with an identification code;
a second tire sensor with a storage device;
an electronic device, connected to a first database, displaying a link diagram upon inputting vehicle data; and
a handheld mobile device, connected to a second database, retrieving a communication protocol from either the first or second database after scanning the link diagram, and the communication protocol is used to connect the first and second tire sensors, and the handheld mobile device includes either a wireless trigger module or a human-machine interface, and the handheld mobile device transmits the identification code in one of the following ways: (1) the wireless trigger module wirelessly activates the first tire sensor to obtain the identification code, and the handheld mobile device connects to the second tire sensor and transmits the identification code to the second tire sensor; (2) the human-machine interface accepts a manual trigger or setting to enter the identification code to the handheld mobile device, and the handheld mobile device reads and transmits the identification code to the second tire sensor.

12. A system for setting a tire sensor communication protocol, comprising:
a tire sensor, which includes at least one sensing module and a first transmission module, and the sensing module detects tire information;
an electronic device, connected to a first database and a reception module, searching the first database after inputting vehicle data into the electronic device, and thereby generating and displaying a link diagram; and
a handheld mobile device, connected to a second database and a second transmission module, after scanning the link diagram, the handheld mobile device retrieves a communication protocol from either the first or second database, and the communication protocol is used to connect the corresponding tire sensor, and the tire sensor transmits said tire information to the handheld mobile device through the first and second transmission modules.

13. The system of claim 12, wherein the second transmission module connects to the reception module to transmit said tire information to the electronic device, and the electronic device includes a first input interface, and the handheld mobile device includes a second input interface, and vehicle information is entered through either the first or second input interface, and said vehicle information in combination with said tire information, is used to create customer service history data in the electronic device.

14. A method for setting a tire sensor communication protocol, comprising the steps of:
using a first device to input vehicle data and then searching an internal or external database for a specified communication protocol command;
forming a link diagram using the specified communication protocol command and displaying the link diagram on the first device;
scanning the link diagram with a second device and executing the communication protocol command;
searching an internal or external database of the second device for a communication protocol based on the communication protocol command; and
using the second device to program a tire sensor with the communication protocol.

15. The method of claim 14, wherein the link diagram includes a communication protocol path, and the second device searches the internal database for the specified communication protocol based on the communication protocol command, and if the specified communication protocol is not found, the second device uses the communication protocol path to download the specified communication protocol from the external database, wherein the external database is a cloud database located on a network server.

16. The method of claim 14, wherein according to the vehicle data, the first device searches the internal or external database to obtain and display a code learning process diagram, and the code learning process diagram assists in operating a vehicle computer to interpret the tire sensor.

17. The method of claim 14, wherein the second device includes an OBD interface, and the OBD interface connects to a vehicle computer, and the second device scans the link diagram so that the communication protocol is obtained from the internal or the external database, and connecting the second device to the vehicle computer with the communication protocol and the OBD interface, and the second device receives an identification code from the vehicle computer, when the second device programs the tire sensor with the communication protocol, the second device simultaneously transmits the identification code to the tire sensor.

18. The method of claim 14, wherein the second device includes a wireless trigger module, and the second device uses the wireless trigger module to trigger the tire sensor and then the second device obtains an identification code from the tire sensor.

19. The method of claim 14, wherein the second device includes a human-machine interface, and the human-machine interface accepts a manual trigger or setting to enter an identification code to the second device, and the second device reads and transmits the identification code to the tire sensor.

20. The method of claim 14, wherein, after programming the tire sensor, the tire sensor sends back the communication protocol and an returned identification code to the second device, and the second device compares the consistency of the returned identification code with an original identification code programmed into the tire sensor, if the two identification codes are consistent, indicating successful programming, and if the two identification codes are not consistent, indicating failed programming.
